(19) United States
(12) Patent Application Publication
(10) Pub. No.: US 2021/0346892 A1
(43) Pub. Date: Nov. 11, 2021

(54) NUCLEIC ACID AMPLIFICATION DEVICE HAVING A PLURALITY OF HEATING BLOCKS

(71) Applicant: MICO BIOMED CO., LTD., Seongnam-si Gyeonggi-Do (KR)

(72) Inventors: Sung Woo KIM, Seoul (KR); Duck Joong KIM, Anyang-Si, Gyeonggi-Do (KR)

(21) Appl. No.: 17/264,669

(22) PCT Filed: Jul. 31, 2019
(86) PCT No.: PCT/KR2019/009517

§ 371 Date: Jan. 29, 2021

(30) Foreign Application Priority Data
Aug. 1, 2018 (KR) 10-2018-0090064

(51) Int. Cl. B01L 7/00; B01L 9/00; B01L 3/00

(52) U.S. Cl. CPC B01L 7/5255; B01L 9/527; B01L 3/502715; B01L 2200/022; B01L 2300/0816; B01L 2300/0609; B01L 2300/123; B01L 2200/0689; B01L 2300/0681; B01L 2300/0883; B01L 2300/1805; B01L 2200/0663

(57) ABSTRACT

One aspect of the present invention provides a nucleic acid amplification device. The device may include a plurality of heating blocks disposed to be spaced apart; a polymerase chain reaction (PCR) chip including an inlet portion into which a solution sample is injected, a reaction chamber in which PCR of the solution sample is performed, and an outlet portion through the solution sample is discharged, the PCR chip coming into sequential contact with the plurality of heating blocks, in which the PCR of the solution sample is performed; a chip holder on which the PCR chip is mounted and which moves the PCR chip to allow the PCR chip to come into sequential contact with the plurality of heating blocks; and a driving portion configured to move the chip holder and to guide a movement direction of the chip holder.

### TECHNICAL FIELD

This application claims priority to and the benefit of Korean Patent Application No. 10-2018-0090064, filed on Aug. 1, 2018, the disclosure of which is incorporated herein by reference in its entirety.

The present invention relates to a nucleic acid amplification device including a plurality of heating blocks and having improved heat efficiency.

### BACKGROUND ART

Polymerase chain reaction (PCR) is a method in which a series of copies of a part of nucleic acid, which has a particular nucleic sequence, is made by repetitively heating and cooling a solution sample including the nucleic acid so as to exponentially amplify the nucleic acid having the particular nucleic sequence part and which is widely used for analysis and diagnosis in the fields of life sciences, genetic engineering, medicine, and the like.

Recently, a variety of PCR devices configured to perform PCR have been developed. As an example, in a PCR device, a container including a solution sample including nucleic acid is mounted in one reaction chamber and PCR is performed by repetitively heating and cooling the container. However, since the PCR device according to the example includes one reaction chamber, an entire structure is not complicated but a complicated circuit for precisely controlling a temperature is necessary. Also, an entire time of an entire PCR necessarily increases due to repetitive heating and cooling of the one reaction chamber. Also, in a PCR device according to another example, a plurality of reaction chambers at a temperature for PCR are installed and a solution sample including nucleic acid is allowed to flow through one channel passing through the reaction chambers so as to perform PCR.

However, since the PCR device according to another example utilizes the plurality of reaction chambers, a complicated circuit for precisely controlling a temperature is unnecessary but a long flow path for passing through the reaction chambers at a high temperature and a low temperature is absolutely necessary such that an entire structure is inevitably complicated. Also, an additional controller configured to control a flow speed of the solution sample including the nucleic acid which flows through the channel passing through the reaction chambers is required.

Accordingly, it is necessary to provide a PCR device having an overall simple structure, minimizing overall PCR time, and obtaining a reliable PCR yield.

### DISCLOSURE

### Technical Problem

The present invention is directed to providing a nucleic acid amplification device in which mobility of a polymerase chain reaction (PCR) chip between heating blocks is improved. It should be noted that objects of the present invention are not limited to the above-described objects, and other objects of the present invention will be apparent to those skilled in the art from the following descriptions.

### Technical Solution

One aspect of the present invention provides a nucleic acid amplification device. The device may include a plurality of heating blocks disposed to be spaced apart; a polymerase chain reaction (PCR) chip including an inlet portion into which a solution sample is injected, a reaction chamber in which PCR of the solution sample is performed, and an outlet portion through the solution sample is discharged, the PCR chip coming into sequential contact with the plurality of heating blocks, in which the PCR of the solution sample is performed; a chip holder on which the PCR chip is mounted and which moves the PCR chip to allow the PCR chip to come into sequential contact with the plurality of heating blocks; and a driving portion configured to move the chip holder and to guide a movement direction of the chip holder.

Specifically, the chip holder may include a first plate horizontally moving between the plurality of heating blocks, a second plate to which the PCR chip is detachably coupled, and an elastic connection portion configured to connect the first plate to the second plate in a vertical direction. Also, the elastic connection portion may generate an elastic force toward the second plate to allow the second plate to come into sequential contact with the plurality of heating blocks while moving in a vertical direction.

Also, specifically, the driving portion may include an operation portion configured to horizontally move the first plate and a guide portion configured to provide a path on which the second plate vertically moves.

Also, specifically, the guide portion may be configured as a recessed space into which a connection member of the second plate is inserted, and the connection member may come into contact with a bottom surface of the recessed space. Here, the bottom surface may be formed to be gradually bent downward in a direction toward the heating blocks.

Also, specifically, the bottom surface of the recessed space of the guide portion which is adjacent to the heating blocks may be located below the heating block so that the elastic connection portion may pressurize the second plate downward against the heating blocks.

Also, specifically, the nucleic acid amplification device may further include a PCR chip case which accommodates the PCR chip therein and which is inserted into the second plate. Here, the PCR chip case may include a top plate and a bottom plate which are couplable, open regions corresponding to the reaction chamber of the PCR chip may be formed in the top plate and the bottom plate, and an accommodation space in which the PCR chip is mounted may be formed in an inner surface of at least one of the top plate and the bottom plate.

Also, specifically, the nucleic acid amplification device may further include a soft sealing portion configured to seal the inlet portion and the outlet portion.

When the PCR chip to which the sealing portion is coupled is accommodated in the PCR chip case, the PCR chip case may pressurize the PCR chip through the sealing portion so as to prevent deformation of the PCR chip caused by stress generated when the PCR chip comes into contact with the heating blocks.

Also, specifically, the nucleic acid amplification device may further include a light source disposed between the plurality of heating blocks and configured to emit light toward the PCR chip, and a detection portion disposed to face the light source and configured to detect the light emitted from the light source.

Also, specifically, the nucleic acid amplification device may further include a plurality of light filters disposed on the light source and configured to filter out light rays in different wavelength bands from the light emitted from the light source; and a filter driving portion configured to horizontally move the plurality of light filters and locate one of the plurality of light filters on the light source.

Also, specifically, the plurality of heating blocks may include a first heating block and a second heating block. Here, the first heating block may be implemented to maintain a temperature of a denaturing step of the PCR or to maintain a temperature of annealing and extension steps of the PCR. The second heating block may be implemented to maintain the temperature of the annealing and extension steps of the PCR or maintain the temperature of the denaturing step of the PCR. Also, the first heating block and the second heating block may be implemented to maintain temperatures of different steps.

Also, specifically, the temperature of the denaturing step may be 90° C. to 100° C., and the temperature of the annealing and extension steps may be 45° C. to 75° C.

### Advantageous Effects

According to the present invention, a polymerase chain reaction (PCR) device including two heating blocks may be provided to efficiently perform nucleic acid amplification reaction.

Also, according to the present invention, without an external force separately applied by a driving portion, a chip holder may move a PCR chip in a vertical direction. Accordingly, merely due to an operation of the driving portion moving the chip holder in a horizontal direction, the PCR chip may come into contact with or be separated from the heating blocks so as to perform PCR.

Also, according to the present invention, since horizontal movement and vertical movement are applied to the PCR chip at the same time, it is possible to perform thermal contact and separation of the PCR chip more naturally and quickly.

### DESCRIPTION OF DRAWINGS

A brief description of the drawings will be provided to more fully understand the drawings referred to in the detailed description of the present invention.

FIGS. 1A and 1B illustrate a nucleic acid amplification device according to one embodiment of the present invention.

FIG. 2 illustrates a chip holder of the nucleic acid amplification device according to one embodiment of the present invention.

FIGS. 3A and 3B illustrate a guide portion of the nucleic acid amplification device according to one embodiment of the present invention.

FIG. 4 illustrates an operation of the nucleic acid amplification device according to one embodiment of the present invention.

FIGS. 5A and 5B illustrate a nucleic acid amplification device according to one embodiment of the present invention.

FIGS. 6 and 7 illustrate a polymerase chain reaction (PCR) chip package according to one embodiment of the present invention.

### MODES OF THE INVENTION

Hereinafter, embodiments of the present invention will be described with reference to the attached drawings. While reference numerals are given to components of each drawing, it should be noted that although shown in different drawings, like components will be referred to as like reference numerals if possible. Also, in a description of the embodiments of the present invention, a detailed description of well-known components or functions of the related art will be omitted when it is deemed to obscure understanding of the embodiments of the present invention. Also, although the embodiments of the present invention will be described below, the technical concept of the present invention is not limited or restricted thereto and a variety of modifications thereof may be made by one of ordinary skill in the art. Meanwhile, vertical and lateral directions which will be described below are on the basis of the drawings for convenience, and the scope of the present invention is not limited to the corresponding directions.

Throughout the specification, when a part is stated as being “connected” to another part, the part is not only “directly connected” but also “indirectly connected” to the other component with another device therebetween. Throughout the specification, when a portion is stated as “including” a component, unless defined particularly otherwise, it means that the portion may not exclude another component but may further include another component. Also, in describing components of the embodiments of the present invention, the terms such as first, second, A, B, (a), (b), and the like may be used. These terms are merely for distinguishing one element from another, and the essence, order, sequence, and the like of corresponding elements are not limited by the terms.

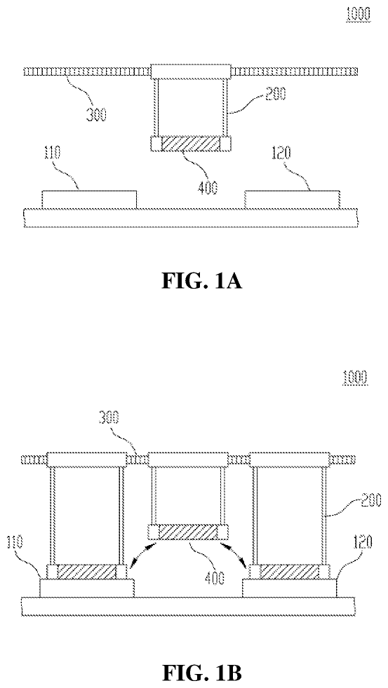

FIGS. 1A and 1B illustrate a nucleic acid amplification device including a plurality of heating blocks according to one embodiment of the present invention.

A nucleic acid amplification device 1000 is a device to be used for polymerase chain reaction (PCR) of amplifying nucleic acid having a particular nucleic sequence. For example, the device 1000 may exponentially amplify deoxyribonucleic acid (DNA) having a particular nucleic sequence by repetitively performing a process, for example, twenty times to forty times that includes a denaturing step of heating a solution sample including double-stranded DNA at a particular temperature, for example, about 95° C. to separate the double-stranded DNA into single-stranded DNA, an annealing step of providing an oligonucleotide primer having a complementary sequence to a particular nucleic sequence to be amplified to the solution sample, cooling with the separated single-stranded DNA at a particular temperature, for example, 55° C., and coupling the primer to the particular nucleic sequence of the single-stranded DNA so as to form a partial DNA-primer compound, and an extension (or amplification) step of maintaining, after the annealing step, the solution sample at an adequate temperature, for example, 72° C., so as to form double-stranded DNA on the basis of the primer of the partial DNA-primer compound using DNA polymerase.

In detail, a device 1000 may include a plurality of heating blocks 110 and 120 disposed to be spaced apart in the same plane, a polymerase chain reaction (PCR) chip 400 in which a PCR of a solution sample is performed, a chip holder 200 configured to move the PCR chip 400 to come into contact with the plurality of heating blocks 110 and 120 sequentially, a driving portion 300 configured to move the chip holder 200, and the PCR chip 400.

The heating blocks 110 and 120 may include a first heating block 110 and a second heating block 120. The first heating blocks 110 and the second heating blocks 120 are configured to maintain temperatures for the denaturing step, annealing step, and extension (amplification) step to amplify nucleic acid. The first heating blocks 110 and the second heating blocks 120 may include a variety of modules configured to provide and maintain the temperatures necessary for the respective steps or may be drivably connected to the modules.

When the PCR chip 400 or the chip holder 200 on which the PCR chip 400 is mounted comes into contact with one surface of each of the heating blocks 110 and 120, the first heating blocks 110 and the second heating blocks 120 may heat an overall contact surface of the PCR chip 400 and maintain a temperature thereof so as to uniformly heat the solution sample in the PCR chip 400 and maintain a temperature thereof. In comparison to a device using a conventional single heating block in which a temperature change rate is within a range of 3 to 7° C. per second, in the present invention, since a temperature change rate in each of the heating blocks is within a range of 20 to 40° C. per second, it is possible to significantly reduce a PCR time.

The first heating block 110 and the second heating block 120 may include heating wires (not shown) therein. The heating wires may be drivably connected to a variety of heat sources to maintain a temperature for performing an annealing step and an extension (or amplification) step and be drivably connected to a variety of temperature sensors configured to monitor temperatures of the heating wires. The heating wires may be disposed to be symmetrical in a vertical and/or lateral direction on the basis of a central point of each heating block surface to uniformly maintain overall internal temperatures of the first heating block 110 and the second heating block 120. A variety of arrangements of heating wires symmetrical in the vertical and/or lateral direction may be provided. Also, the first heating block 110 and the second heating block 120 may include thin film heaters (not shown) therein. The thin film heaters may be disposed to be spaced at certain intervals apart in the vertical and/or lateral direction on the basis of the central point of each heating block surface to uniformly maintain overall internal temperatures of the first heating block 110 and the second heating block 120. A variety of uniform arrangements of thin film heaters in the vertical and/or lateral direction may be provided.

To quickly distribute or transfer heat to the same area, the first heating block 110 and the second heating block 120 may include a metal material, for example, an aluminum material, or may be formed of an aluminum material but is not limited thereto.

The first heating blocks 110 may be implemented to maintain an adequate temperature for performing the denaturing step or annealing and extension (or amplification) steps. For example, the first heating blocks 110 may maintain a temperature of 45° C. to 100° C. When the first heating blocks 110 perform the denaturing step, a temperature of 90° C. to 100° C. may be maintained. On the other hand, when the first heating blocks 110 perform the annealing and extension (or amplification) steps, a temperature of 45° C. to 75° C. may be maintained.

Similarly, the second heating blocks 120 may also be implemented to maintain an adequate temperature for performing the denaturing step or annealing and extension (or amplification) steps.

For example, the second heating blocks 120 may maintain a temperature of 45° C. to 100° C. When the second heating blocks 120 perform the denaturing step, a temperature of 90° C. to 100° C. may be maintained. On the other hand, when the second heating blocks 120 perform the annealing and extension (or amplification) steps, a temperature of 45° C. to 75° C. may be maintained.

Temperatures at which the first heating blocks 110 and the second heating blocks 120 can perform the denaturing step or the annealing and extension (or amplification) steps are not limited thereto. However, the first heating blocks 110 and the second heating blocks 120 may be implemented to maintain different temperatures to perform different steps.

The first heating blocks 110 and the second heating blocks 120 may be disposed to be spaced at predetermined distances apart so as to prevent mutual heat exchange therebetween. Accordingly, since heat exchange does not occur between the first heating blocks 110 and the second heating blocks 120, it is possible to precisely control temperatures of the denaturing step and the annealing and extension (or amplification) steps in a nucleic acid amplification reaction which receives a significant influence from a minute temperature change.

The chip holder 200 may provide a space in which the PCR chip 400 is stably mounted and may transfer movement caused by the driving portion to the PCR chip 400. An inner wall of the chip holder 200 may have a shape and a structure to be fixedly mounted on the outer wall of the PCR chip 400 to prevent the PCR chip 400 from being detached from the chip holder 200 when the nucleic acid amplification reaction is performed.

The driving portion 300 may include all means configured to allow the chip holder 200, on which the PCR chip 400 is mounted, to be movable above the first heating block 110 and the second heating block 120. The driving portion 300 may include an operation portion including a rail extending in a horizontal direction and a motor member configured to move the chip holder 200 using the rail. Due to horizontal movement of the driving portion 300, the chip holder 200 on which the PCR chip 400 is mounted may reciprocate between the first heating block 110 and the second heating block 120.

Also, with or without the horizontal movement of the driving portion 300, the chip holder 200 may allow each of the heating blocks 110 and 120 to come into contact with or be separated from the PCR chip 400 by vertically moving the PCR chip 400. To this end, the driving portion 300 may include a guide portion 310 for vertical movement of the chip holder 200.

The PCR chip 400 may come into contact with one surface of each of the first heating blocks 110 and the second heating blocks 120 and may include a solution sample including nucleic acid, for example, double-stranded DNA, oligonucleotide primer having a complementary nucleic sequence to a particular nucleic sequence to be amplified, DNA polymerase, deoxyribonucleotide triphosphates (dNTP), and a PCR buffer. The PCR chip 400 may include an inlet portion into which the solution sample is injected, a reaction chamber (or channel) in which nucleic acid amplification reaction of the solution sample is performed, and an outlet portion configured to discharge the solution sample on which the nucleic acid amplification reaction is completely performed. When the PCR chip 400 comes into contact with the first heating blocks 110 or the second heating blocks 120, heat of the first heating blocks 110 or the second heating blocks 120 may be transferred to the PCR chip 400 and the solution sample included in the reaction chamber (or channel) of the PCR chip 400 may be heated and a temperature thereof may be maintained. Also, the PCR chip 400 may have a flat panel shape overall but is not limited thereto. Also, an outer wall of the PCR chip 400 may have a shape and a structure to be fixedly mounted in an internal space of the chip holder 200 to prevent the PCR chip 400 from being detached from the chip holder 200 when the nucleic acid amplification reaction is performed.

First, the device 1000 may introduce a solution sample including nucleic acid, for example, double-stranded deoxyribonucleic acid (DNA), an oligonucleotide primer having a nucleic sequence that is complementary to a particular nucleic sequence to be amplified, DNA polymerase, deoxyribonucleotide triphosphates (DNTP), and a PCR buffer to the PCR chip 400 and may mount the PCR chip 400 on the chip holder 200.

Subsequently or simultaneously, a step of heating and maintaining the first heating block 110 at a temperature for denaturing, for example, 90° C. to 100° C., and preferably, at a temperature of 95° C., may be performed. A step of heating and maintaining the second heating block 120 at a temperature for a step of annealing and extension (or amplification), for example, 45° C. to 75° C., may be performed.

The chip holder 200 may be moved toward the first heating block 110 using the driving portion 300 and the PCR chip 400 may be allowed to come into contact with the first heating block 110 so as to perform a first denaturing step of PCR.

Subsequently, the first denaturing step of PCR may be finished by moving the chip holder 200 toward the second heating block 120 using the driving portion 300 and separating the PCR chip 400 from the first heating block 110, and the PCR chip 400 may come into contact with the second heating block 120 so as to perform a first annealing and extension (or amplification) step of PCR.

Finally, the first annealing and extension (or amplification) step of PCR may be finished by separating the chip holder 200 from the second heating block 120 using the driving portion 300 so as to finish a first circulation of PCR. A plurality of such PCR may be performed.

Here, when the driving portion 300 moves the chip holder 200 toward the first heating block 110 or the second heating block 120, the chip holder 200 may move the PCR chip 400 downward so as to allow each of the heating blocks 110 and 120 to come into contact with the PCR chip 400. On the other hand, when the chip holder 200 is moved from the first heating block 110 or the second heating block 120 toward a center, the chip holder 200 may move the PCR chip 400 upward so as to separate the PCR chip 400 from each of the heating blocks.

That is, in the present invention, since the chip holder 200 can move the PCR chip 400 in a vertical direction, it is unnecessary that the driving portion 300 moves the PCR chip 400 and/or the chip holder 200 in the vertical direction to attach or detach the PCR chip 400 to or from the heating block. Accordingly, the PCR chip 400 may come into contact with or be separated from the heating block 110 or 120 easily merely due to an operation of moving, by the driving portion 300, the chip holder 200 in a horizontal direction so as to perform PCR.

Also, in the present invention, since horizontal movement and vertical movement are not sequentially/separately performed on the PCR chip 400 but performed simultaneously, thermal contact and separation of the PCR chip 400 may be more naturally and quickly performed.

Although the PCR chip 400 is shown in FIGS. 1A and 1B as being mounted on the chip holder 200, this is merely an example and a PCR chip package, which will be described below, may be mounted on the chip holder 200 according to an embodiment. Although the PCR chip 400 is shown in FIGS. 1A and 1B, and FIGS. 2 to 7 described below as being disposed on the chip holder 200 for convenience, this includes the PCR chip 400 being disposed separately or being disposed in the PCR chip package.

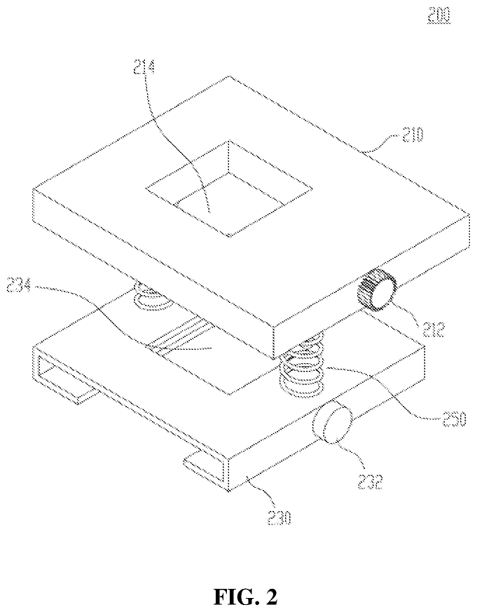

FIG. 2 illustrates the chip holder of the nucleic acid amplification device according to one embodiment of the present invention.

The chip holder 200 may include a first plate 210, a second plate 230, and an elastic connection portion 250.

The first plate 210 may have a flat panel shape and be connected to the driving portion 300 using a first connection member 212 and be moved by the driving portion 300 in a horizontal direction.

The second plate 230 may be connected to the first plate 210 in a vertical direction and provide a space therebelow in which the PCR chip 400 is mounted. In detail, the second plate 230 includes bent portions formed inward on both ends so as to allow the PCR chip 400 or the PCR chip package to be slidably coupled thereto.

Also, the second plate 230 may be connected to the driving portion 300, more particularly, to the guide portion 310 of the driving portion 300 using a second connection member 232 so as to move in the vertical direction while the first plate 210 moves in the horizontal direction as is described in more detail below.

Also, the first plate 210 and the second plate 230 may include through portions 214 and 234 formed in regions corresponding to each other. The corresponding regions correspond to a reaction chamber or a reaction channel of the PCR chip 400 and are configured to detect a PCR result while the PCR chip 400 is mounted on the chip holder 200 as is described in more detail below.

The elastic connection portion 250 is configured to connect the first plate 210 to the second plate 230 in a vertical direction and may include, for example, an elastic member such as a spring and the like. The elastic connection portion 250 may allow the second plate 230 to vertically move and come into sequential contact with the plurality of heating blocks 110 and 120 according to the horizontal movement of the first plate 210 and may generate an elastic force toward the second plate 230 to allow the PCR chip 400 to come into closer contact with the heating blocks 110 and 120.

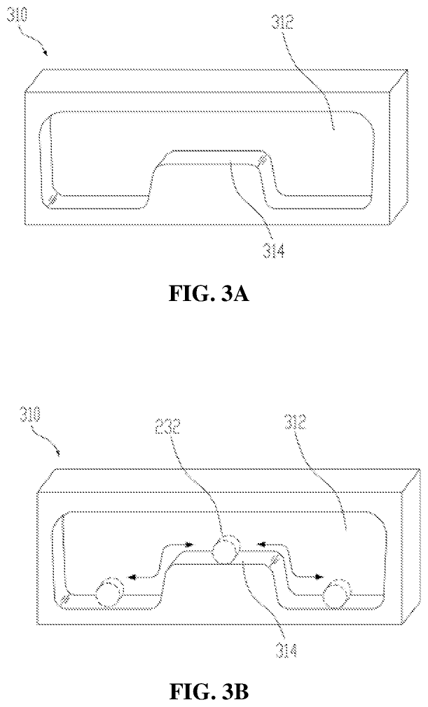

FIGS. 3A and 3B illustrate a guide portion of the nucleic acid amplification device according to one embodiment of the present invention.

The guide portion 310 of the driving portion 300 may be configured to move the chip holder 200, particularly, the second plate 230 of the chip holder 200 in the vertical direction and may be provided as a vertical flat panel and include a recessed space 312 in one side surface.

One end of the first plate 210 of the chip holder 200 may be disposed at a top end of the guide portion 310 to support the first plate 210.

Also, the second connection member 232 of the second plate 230 may be disposed in the recessed space 312 of the guide portion 310. Due to an elastic force generated from the elastic connection portion 250 toward the second plate 230, here, the second connection member 232 may be pressed against a bottom surface 314 of the recessed space 312.

Accordingly, when the first plate 210 is moved in a horizontal direction (a lateral direction in FIGS. 3A and 3B) due to the driving portion 300, the second connection member 232 of the second plate 230 moves along the bottom surface 314 of the recessed space 312 so that the second plate 230 may move in the vertical direction.

That is, when the first plate 210 moves both ways, the second plate 230 moves downward. When the first plate 210 moves toward the center, the second plate 230 may move upward.

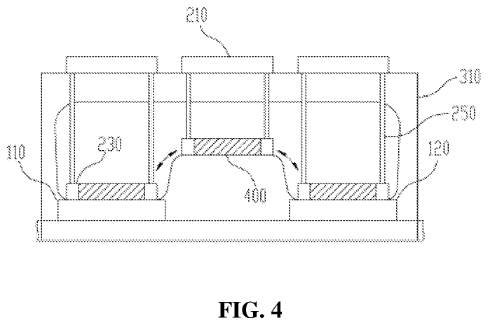

FIG. 4 illustrates an operation of the nucleic acid amplification device according to one embodiment of the present invention.

Referring to FIG. 4, the chip holder 200 on which the PCR chip 400 is disposed may be located in the center of the guide portion 310. Here, the one end of the first plate 210 of the chip holder 200 may be disposed at the top end of the guide portion 310, and the second connection member 232 of the second plate 230 may be located on the bottom surface 314 of the center of the recessed space 312. The PCR chip 400 may remain in a neutral state without coming into contact with the heating blocks 110 and 120.

The chip holder 200 (particularly, the first plate 210) may be moved toward the first heating block 110 using the driving portion 300. The one end of the first plate 210 of the chip holder 200 may move leftward from the top end of the guide portion 310, and the second connection member 232 of the second plate 230 may also move leftward along the bottom surface 314 of the recessed space 312. Here, due to the elastic force of the elastic connection portion 250, the second connection member 232 moves while being pressed against the bottom surface 314 of the recessed space 312 so that the entire second plate 230 may move downward and come into contact with the first heating block 110.

Subsequently, the chip holder 200 may be moved toward the second heating block 120 using the driving portion 300. When the second connection member 232 of the second plate 230 moves while being pressed against the bottom surface 314 of the recessed space 312 such that the first plate 210 moves rightward along the top end of the guide portion 310, the second plate 230 may move upward and remain in the neutral state and then may move downward and come into contact with the second heating block 120.

Particularly, a region of the bottom surface 314 of the recessed space 312 in the guide portion 310, which is adjacent to the heating blocks 110 and 120, is located below the heating blocks 110 and 120 so that the elastic connection portion 250 may more firmly press the second plate 230 downward against the heating blocks 110 and 120.

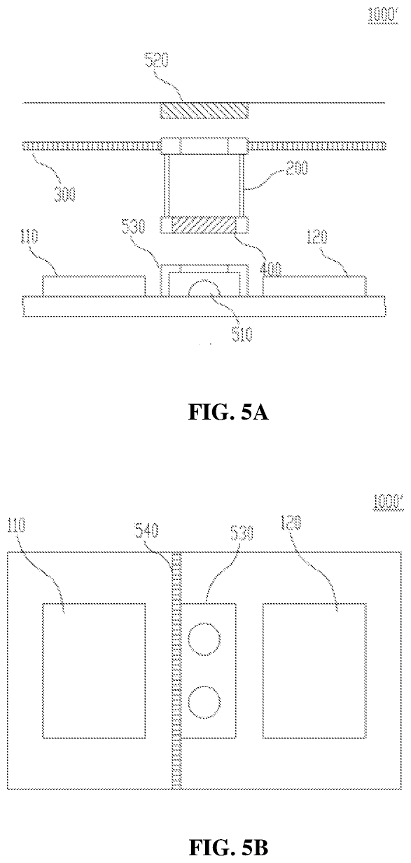

FIGS. 5A and 5B illustrate a nucleic acid amplification device according to one embodiment of the present invention.

A device 1000′ may include a light source 510, a detection portion 520, a light filter 530, and a filter driving portion 540.

The light source 510 may be located between the heating blocks 110 and 120 and emit light toward the PCR chip 400. The light source 510 may be selected from the group consisting of a mercury arc lamp, a xenon arc lamp, a tungsten arc lamp, a metal halide arc lamp, metal halide fibers, and light emitting diodes (LED). Also, a wavelength of the light source 510 may be selected within a range from about 200 nm to 1300 nm or may be implemented as multiple wavelengths using multiple light source 510 or a filter.

The detection portion 520 is configured to detect the light emitted from the light source 510 and may be selected from the group consisting of a charged-coupled device (CCD), a charge-injection device (CID), a complementary metal-oxide-semiconductor (CMOS) detector, and a photomultiplier tube (PMT).

The light source 510 may be disposed between the heating blocks 110 and 120, and the detection portion 520 may be disposed above the light source 510 and the chip holder 200. Also, the chip holder 200 on which the PCR chip 400 is disposed may include the through portions 214 and 234 formed in regions of the first plate 210 and the second plate 230, which correspond to the reaction chamber or the reaction channel of the PCR chip 400. Accordingly, while the PCR chip 400 performs PCR while reciprocating between the first heating block 110 and the second heating block 120 (for example, when the PCR chip 400 is in the neutral state shown in FIG. 4), PCR may be measured and analyzed in real time.

In this case, an additional fluorescent material may be further added to the solution sample included in the PCR chip 400 and may emit light due to light having a particular wavelength according to production of a PCR product so as to cause a measurable and analyzable light signal.

The light filter 530 may be disposed on an optical path of the light source 510 to be adjacent to the light source 510 and may filter out light of a particular wavelength band from the light emitted from the light source 510. A plurality of such light filters 530 may be provided and may each filter out light of a different wavelength band.

The filter driving portion 540 may be coupled to the light filter 530 and may horizontally move the light filter 530. One of a plurality of such light filters 530 may be located on the light source 510 for horizontal movement so as to emit light in a wavelength band needed for detection toward the PCR chip 400. For example, the filter driving portion 540 may include an operation portion including a rail extending in a horizontal direction and a motor member configured to move the light filter 530 using the rail.

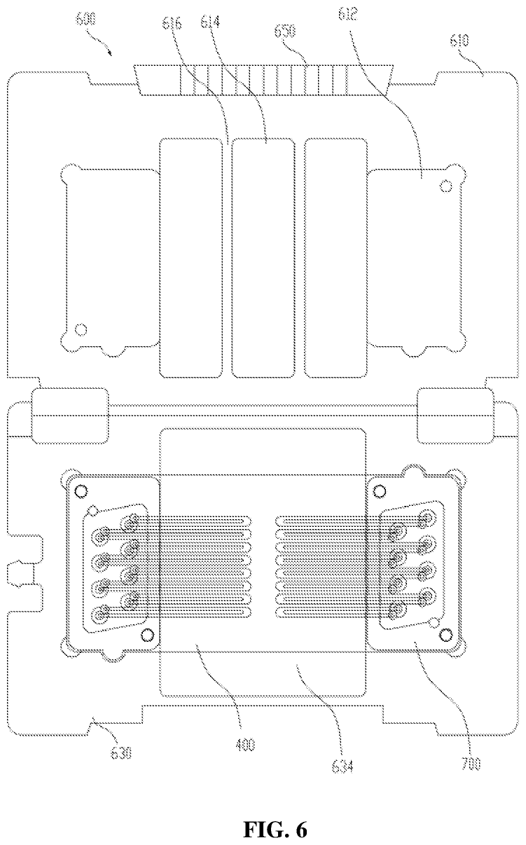

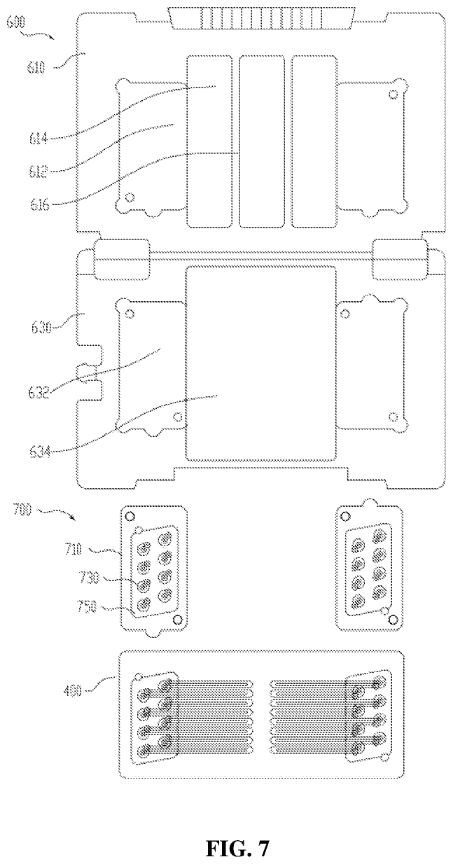

FIGS. 6 and 7 illustrate a PCR chip package according to one embodiment of the present invention.

In detail, FIG. 6 illustrates an assembling view of the PCR chip package, and FIG. 7 illustrates an exploded view of the PCR chip package.

The PCR chip package may accommodate the PCR chip 400 therein, be inserted into the chip holder 200, move with the chip holder 200, and allow the PCR chip 400 to come into more stable and firm contact with the heating blocks 110 and 120. In detail, the PCR chip package may include the PCR chip 400, a PCR chip case 600, and a sealing portion 700.

The PCR chip 400 may include a solution sample including nucleic acid, for example, double-stranded DNA, oligonucleotide primer having a complementary nucleic sequence to a particular nucleic sequence to be amplified, DNA polymerase, dNTP, and a PCR buffer.

The PCR chip 400 may include an inlet portion configured to introduce the solution sample, an outlet portion configured to discharge the solution sample on which nucleic acid amplification reaction is completed, and one or more PCR chambers (or channels) which accommodate the solution sample including nucleic acid to be amplified. The PCR chip 400 may be implemented using a light transmitting material and, preferably, includes a light transmitting plastic material. For example, since a plastic material is used, the PCR chip 400 may facilitate an increase in heat transfer efficiency by adjusting a thickness of plastic and manufacturing costs thereof may be reduced due to a simple manufacturing process.

The PCR chip case 600 may include a top plate 610 and a bottom plate 630 and may be opened or closed through hinge-pivoting between the top plate 610 and the bottom plate 630. In an open state, the PCR chip 400 and/or the sealing portion 700 may be accommodated in or eliminated from the PCR chip case 600. In a closed state, the PCR chip 400 and/or the sealing portion 700 therein may be pressurized to be stably disposed. Also, through sliding of a coupling member 650, the top plate 610 and the bottom plate 630 may selectively remain in the closed state.

To accommodate the PCR chip 400 in the PCR chip case 600, accommodation spaces 612 and 631 in which the PCR chip 400 is mounted may be formed in one inner surfaces of the top plate 610 and the bottom plate 630. Accommodation spaces 612 and 632 may be formed to have sizes corresponding to or smaller than the PCR chip 400 coupled to the sealing portion 700. Accordingly, when the PCR chip case 600 is closed, the PCR chip 400 may be fixedly pressurized using the sealing portion 700 which is soft. Accordingly, deformation of the PCR chip 400 caused by stress generated when the PCR chip 400 comes into contact with the heating blocks 110 and 120 may be prevented.

Also, to allow PCR to be observable while the PCR chip 400 is disposed in the PCR chip case 600 or the chip holder 200, the top plate 610 and the bottom plate 630 may include open regions 614 and 633 formed corresponding to the reaction chamber of the PCR chip 400.

Also, the PCR chip 400 may come into close contact with the heating blocks 110 and 120 through the open regions 634 of the bottom plate 630. At least one support portion 616 configured to come into contact with the PCR chip 400 may be formed in an open region 614 of a top plate 610 to prevent stress generated toward the PCR chip 400 when the PCR chip 400 comes into contact with the heating blocks 110 and 120.

The sealing portion 700 may seal the inlet portion and the outlet portion of the PCR chip 400. To this end, the sealing portion 700 may include a soft material such as rubber and the like and have flexibility and elasticity. In detail, the sealing portion 700 may include a cover portion 710 having a flat panel shape and a plurality of protruding portions 730 formed on the cover portion 710, and each of the protruding portions 730 may be inserted into the inlet portion and the outlet portion of the PCR chip 400 so as to seal the PCR chip 400.

Also, the sealing portion 700 and the PCR chip 400 may have corresponding shapes to be more firmly pressed against each other. For example, the PCR chip 400 may include protruding regions which surround an inlet portion and an outlet portion, and the sealing portion 700 may include an accommodation region 750 formed to be recessed in which the protruding regions of the PCR chip 400 are accommodated to be pressed thereagainst.

As described above, optimum embodiments have been shown and described in the drawings and the specification. The particular terms used herein are merely intended to describe the present invention and are not used to limit the meanings or restrict the scope of the present invention disclosed in the claims. Therefore, it should be understood by one of ordinary skill in the art that a variety of modifications and equivalents thereof may be made. Accordingly, the technical scope of the present invention should be determined by the technical concept of the following claims.

1. A nucleic acid amplification device comprising:
a plurality of heating blocks disposed to be spaced apart;
a polymerase chain reaction (PCR) chip comprising an inlet portion into which a solution sample is injected; a reaction chamber in which PCR of the solution sample is performed; and an outlet portion through the solution sample is discharged, the PCR chip coming into sequential contact with the plurality of heating blocks, in which the PCR of the solution sample is performed;
a chip holder on which the PCR chip is mounted and which moves the PCR chip to allow the PCR chip to come into sequential contact with the plurality of heating blocks; and
a driving portion configured to move the chip holder and to guide a movement direction of the chip holder.

2. The nucleic acid amplification device of claim 1, wherein the chip holder comprises a first plate horizontally moving between the plurality of heating blocks, a second plate to which the PCR chip is detachably coupled, and an elastic connection portion configured to connect the first plate to the second plate in a vertical direction, and
wherein the elastic connection portion generates an elastic force toward the second plate to allow the second plate to come into sequential contact with the plurality of heating blocks while moving in a vertical direction.

3. The nucleic acid amplification device of claim 2, wherein the driving portion comprises an operation portion configured to horizontally move the first plate and a guide portion configured to provide a path on which the second plate vertically moves.

4. The nucleic acid amplification device of claim 3, wherein the guide portion is configured as a recessed space into which a connection member of the second plate is inserted, and the connection member comes into contact with a bottom surface of the recessed space, in which the bottom surface is formed to be gradually bent downward in a direction toward the heating blocks.

5. The nucleic acid amplification device of claim 4, wherein the bottom surface of the recessed space of the guide portion which is adjacent to the heating blocks is located below the heating block so that the elastic connection portion pressurizes the second plate downward against the heating blocks.

6. The nucleic acid amplification device of claim 2, further comprising a PCR chip case which accommodates the PCR chip therein and which is inserted into the second plate, wherein the PCR chip case includes a top plate and a bottom plate which are couplable, open regions corresponding to the reaction chamber of the PCR chip are formed in the top plate and the bottom plate, and an accommodation space in which the PCR chip is mounted is formed in an inner surface of at least one of the top plate and the bottom plate.

7. The nucleic acid amplification device of claim 6, further comprising a soft sealing portion configured to seal the inlet portion and the outlet portion.

8. The nucleic acid amplification device of claim 7, wherein when the PCR chip to which the sealing portion is coupled is accommodated in the PCR chip case, the PCR chip case pressurizes the PCR chip through the sealing portion so as to prevent deformation of the PCR chip caused by stress generated when the PCR chip comes into contact with the heating blocks.

9. The nucleic acid amplification device of claim 1, further comprising:
a light source disposed between the plurality of heating blocks and configured to emit light toward the PCR chip; and
a detection portion disposed to face the light source and configured to detect the light emitted from the light source.

10. The nucleic acid amplification device of claim 9, further comprising:
a plurality of light filters disposed on the light source and configured to filter out light rays in different wavelength bands from the light emitted from the light source; and
a filter driving portion configured to horizontally move the plurality of light filters and locate one of the plurality of light filters on the light source.

11. The nucleic acid amplification device of claim 1, wherein the plurality of heating blocks comprise a first heating block and a second heating block,
wherein the first heating block is implemented to maintain a temperature of a denaturing step of the PCR or to maintain a temperature of annealing and extension steps of the PCR,
wherein the second heating block is implemented to maintain the temperature of the annealing and extension steps of the PCR or maintain the temperature of the denaturing step of the PCR, and
wherein the first heating block and the second heating block are implemented to maintain temperatures of different steps.

12. The nucleic acid amplification device of claim 11, wherein the temperature of the denaturing step is 9° C. to 100° C., and the temperature of the annealing and extension steps is 45° C. to 75° C.
